(19) United States
(12) Patent Application Publication
(10) Pub. No.: US 2026/0014461 A1
(43) Pub. Date: Jan. 15, 2026

(54) TRACKING METHOD, MULTI-DEVICE SYSTEM AND NON-TRANSITORY COMPUTER READABLE STORAGE MEDIUM

(71) Applicant: HTC Corporation, Taoyuan City (TW)

(72) Inventor: Chun-Kai HUANG, Taoyuan City (TW)

(21) Appl. No.: 19/266,179

(22) Filed: Jul. 11, 2025

Related U.S. Application Data
(60) Provisional application No. 63/670,121, filed on Jul. 12, 2024.
(60) Provisional application No. 63/670,122, filed on Jul. 12, 2024.

(51) Int. Cl. A63F 13/428; A63F 13/212; A63F 13/213

(52) U.S. Cl. CPC A63F 13/428; A63F 13/212; A63F 13/213

(57) ABSTRACT

The present disclosure provides a tracking method and a multi-device system. The multi-device system is configured to track a player device in a physical environment and includes a host device and a peripheral device. The tracking method includes: by the peripheral device, obtaining a spatial relationship between the player device and the peripheral device attached to the player device; by the peripheral device, transmitting the spatial relationship and a first pose of the peripheral device to the host device, wherein the first pose is generated by the peripheral device attached to the player device; by the host device, generating a second pose of the player device according to the spatial relationship and the first pose; and in response to a detection of the spatial relationship being unqualified, by the peripheral device, updating the spatial relationship.

### CROSS-REFERENCE TO RELATED APPLICATION

This application claims priority to U.S. Provisional Application Ser. No. 63/670,121, filed Jul. 12, 2024, and U.S. Provisional Application Ser. No. 63/670,122, filed Jul. 12, 2024, the disclosures of which are incorporated herein by reference in their entireties.

### BACKGROUND

### Field of Invention

This disclosure relates to a method and a system, in particular to a tracking method and a multi-device system.

### Description of Related Art

In the technical field of the virtual reality (VR), augmented reality (AR) and/or mixed reality (MR), some related arts may provide the user with various experiential devices having different physical forms, such as gun, baseball bat, racquet, fire extinguisher, boxing gloves, etc., so that the user can interact with the particular virtual reality content as in the real world. However, if the experiential devices are not well tracked and thus are mistakenly rendered in the field of view of the user, the user may have a bad experience or immersion. Therefore, it is important to propose a new approach for tracking the experiential devices.

### SUMMARY

An aspect of present disclosure relates to a tracking method applicable to a multi-device system. The multi-device system is configured to track a player device in a physical environment and includes a host device and a peripheral device. The tracking method includes: by the peripheral device, obtaining a spatial relationship between the player device and the peripheral device attached to the player device; by the peripheral device, transmitting the spatial relationship and a first pose of the peripheral device to the host device, wherein the first pose is generated by the peripheral device attached to the player device; by the host device, generating a second pose of the player device according to the spatial relationship and the first pose, wherein the spatial relationship, the first pose and the second pose are defined in a spatial coordinate system; and in response to a detection of the spatial relationship being unqualified, by the peripheral device, updating the spatial relationship between the player device and the peripheral device attached to the player device.

Another aspect of present disclosure relates to a multi-device system. The multi-device system is configured to track a player device in a physical environment and includes a host device and a peripheral device. The peripheral device is configured to obtain a spatial relationship between the player device and the peripheral device attached to the player device, and is configured to, in response to a detection of the spatial relationship being unqualified, update the spatial relationship between the player device and the peripheral device attached to the player device. The host device is configured to receive the spatial relationship and a first pose of the peripheral device from the peripheral device, and is configured to generate a second pose of the player device according to the spatial relationship and the first pose. The first pose is generated by the peripheral device attached to the player device, and the spatial relationship, the first pose and the second pose are defined in a spatial coordinate system.

Another aspect of present disclosure relates to a non-transitory computer readable storage medium with a computer program to execute a tracking method applicable to a multi-device system. The multi-device system is configured to track a player device in a physical environment and includes a host device and a peripheral device. The tracking method includes: by the peripheral device, obtaining a spatial relationship between the player device and the peripheral device attached to the player device; by the peripheral device, transmitting the spatial relationship and a first pose of the peripheral device to the host device, wherein the first pose is generated by the peripheral device attached to the player device; by the host device, generating a second pose of the player device according to the spatial relationship and the first pose, wherein the spatial relationship, the first pose and the second pose are defined in a spatial coordinate system; and in response to a detection of the spatial relationship being unqualified, by the peripheral device, updating the spatial relationship between the player device and the peripheral device attached to the player device.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a multi-device system in accordance with some embodiments of the present disclosure;

FIG. 2 is a flow diagram of a tracking method in accordance with some embodiments of the present disclosure;

FIG. 3 is a flow diagram of one operation of the tracking method in accordance with some embodiments of the present disclosure;

FIGS. 4A and 4B are schematic diagrams of a procedure for obtaining a spatial relationship between the player device and a peripheral device, which is attached to the player device, of the multi-device system in accordance with some embodiments of the present disclosure;

FIG. 5 is a flow diagram of one operation of the tracking method in accordance with some embodiments of the present disclosure;

FIG. 6 is a schematic diagram of another procedure for obtaining a spatial relationship between the player device and the peripheral device attached to the player device in accordance with some embodiments of the present disclosure;

FIG. 7 is a flow diagram of one operation of the tracking method in accordance with some embodiments of the present disclosure;

FIG. 8 is a schematic diagram of an image frame captured by the peripheral device in accordance with some embodiments of the present disclosure;

FIG. 9 is a flow diagram of one operation of the tracking method in accordance with some embodiments of the present disclosure;

FIG. 10 is a schematic diagram of an image frame captured by the peripheral device in accordance with some embodiments of the present disclosure;

FIG. 11 is a schematic diagram of a host device or another peripheral device of the multi-device system verifying the spatial relationship between the peripheral device and the player device in accordance with some embodiments of the present disclosure;

FIG. 12 is a flow diagram of the tracking method in accordance with some embodiments of the present disclosure;

FIG. 13 is a flow diagram of one operation of the tracking method in accordance with some embodiments of the present disclosure;

FIG. 14 is a schematic diagram of an image frame captured by the host device in accordance with some embodiments of the present disclosure; and

FIG. 15 is a flow diagram of the tracking method in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

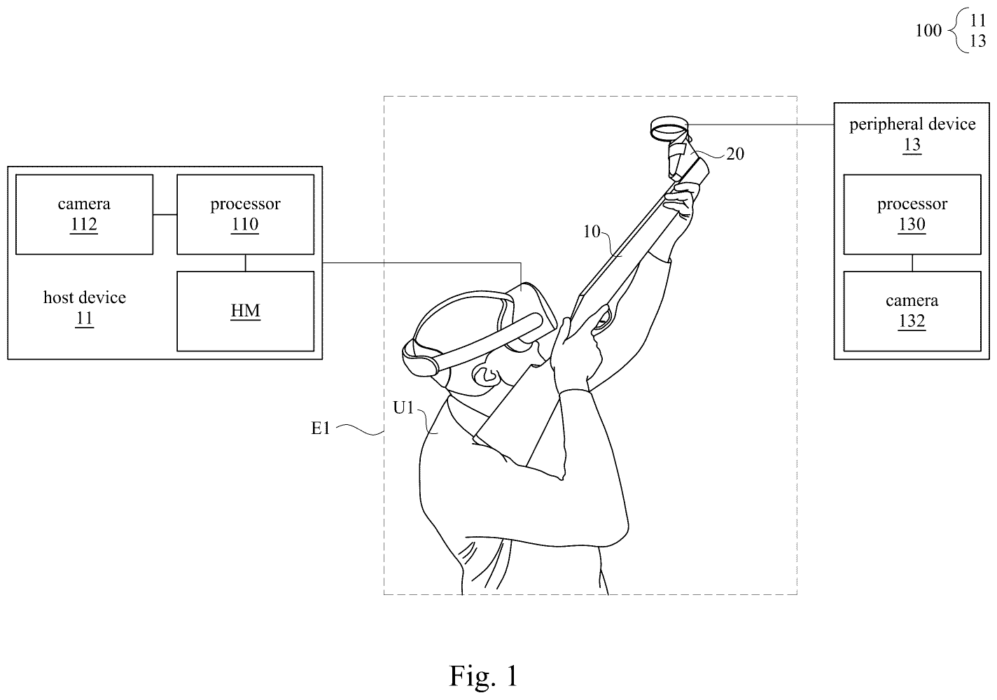

Referring to FIG. 1, FIG. 1 is a schematic diagram of a multi-device system 100 in accordance with some embodiments of the present disclosure. In some embodiments, the multi-device system 100 can be operated by a user U1 in a physical environment E1, such as a gaming place, a workplace, a house, etc.

In the embodiments of FIG. 1, the multi-device system 100 includes a host device 11 and a peripheral device 13. In some practical applications, as shown in FIG. 1, the host device 11 can be implemented by a wearable display device (e.g., a head-mounted device (HMD)), and can be worn on the head of the user U1. Also, the peripheral device 13 can be implemented by a controller device (e.g., a handheld controller, a wearable controller, etc.), and can be used by the user U1 to control, for example the wearable display device. The wearable display device and the controller device can be operated together as an immersive system, and the immersive system is configured to provide an immersive experience for the user U1. For example, the user U1's perception of the physical environment E1 is replaced or embellished with an immersive environment displayed by the wearable display device, such as an augmented reality (AR) environment, a virtual reality (VR) environment, a mixed reality (MR) environment, etc. The immersive environment includes at least one virtual object, which cannot be directly seen in the physical environment E1 by the user U1. In addition, the user U1 can control the at least one virtual object in the immersive environment by operating the controller device or by some hand movements.

In some embodiments, as shown in FIG. 1, the immersive system further provides the user U1 a player device 10 to improve the user U1's immersion in the immersive environment. In particular, in the embodiments of FIG. 1, the immersive environment is a shooting scene, such as shooting sports, hunting, etc., and the player device 10 is in the shape of rifle suiting the shooting scene. However, the present disclosure is not limited herein. For example, in some embodiments, the player device 10 can be in the shape of baseball bat, badminton racket, tennis racket, boxing gloves, etc., according to the type of the immersive environment. Furthermore, the peripheral device 13 can be attached to the player device 10. In such arrangements, the user U1 can operate the player device 10 with proper shape to interact with the at least one virtual object in the particular immersive environment, such as virtual target, virtual prey, virtual ball, virtual opponent, etc., which allows the user U1 for well immersion in the immersive environment.

In some further embodiments, the multi-device system 100 further includes a connection device 20. As shown in FIG. 1, the connection device 20 can be disposed on the player device 10, and is configured to secure the peripheral device 13 by various means, such as Hook-and-loop fastener, snap-fit, clamp, etc. In other words, in some embodiments, the peripheral device 13 is attached to the player device 10 through the connection device 20.

In some embodiments, the host device 11 is configured to localize at least one of itself, the peripheral device 13 and the player device 10 in the physical environment E1, and is configured to provide a visual feedback for the user U1 based on the localization of at least one of itself, the peripheral device 13 and the player device 10. Accordingly, as shown in FIG. 1, the host device 11 includes a processor 110 and a camera 112. In particular, the processor 110 is electrically and/or communicatively coupled to the camera 112.

In the above embodiments of the host device 11, the camera 112 is configured to capture multiple images in the physical environment E1. It should be understood that these images captured by the camera 112 may include at least one of images of the whole or partial physical environment E1, images of the peripheral device 13, images of the player device 10 and images of the user U1. The processor 110 is configured to apply some feature extraction based localization technologies (e.g., Simultaneous Localization and Mapping (SLAM)) to the images captured by the camera 112, to establish a map data HM of the physical environment E1 and to calculate the position and/or orientation of at least one of the host device 11, the peripheral device 13 and the player device 10 in the map data HM. The processor 110 is configured to apply some interaction-based tracking technologies (e.g., optical tracking) to the images captured by the camera 112, to calculate the position and/or orientation of at least one of the peripheral device 13 and the player device 10 in the map data HM. Also, the processor 110 is configured to generate at least one visual content according to the position and/or orientation of at least one of the host device 11, the peripheral device 13 and the player device 10, so that the host device 11 can display the immersive environment (i.e., the visual feedback) for the user U1.

In some embodiments, the peripheral device 13 is configured to localize at least one of itself and the player device 10 in the physical environment E1, and is configured to communicate with the host device 11 to operate in the same spatial coordinate system as the host device 11. Accordingly, as shown in FIG. 1, the peripheral device 13 includes a processor 130 and a camera 132. In particular, the processor 130 is electrically and/or communicatively coupled to the camera 132.

In the above embodiments of the peripheral device 13, the camera 132 is configured to capture multiple images in the physical environment E1. It should be understood that these images captured by the camera 132 may include at least one of images of the whole or partial physical environment E1, images of the host device 11, images of the player device 10 and images of the user U1. By applying some feature extraction based localization technologies (e.g., SLAM) and/or some interaction-based tracking technologies (e.g., optical tracking), the processor 130 is configured to calculate the position and/or orientation of at least one of the peripheral device 13 and the player device 10 in the map data HM according to the images captured by the camera 132 and the map data HM shared by the host device 11.

In the above embodiments, each of the processor 110 and the processor 130 can be implemented with a central processing unit (CPU), a graphic processing unit (GPU), an application-specific integrated circuit (ASIC), a microprocessor, a system on a Chip (SoC) or other suitable processing circuits.

It should be understood that the host device 11 and the peripheral device 13 are not limited to the structures shown in FIG. 1. For example, in some embodiments, each of the host device 11 and the peripheral device 13 can further include a motion sensor (e.g., an inertial measurement unit (IMU) including an accelerometer, a gyroscope and/or a magnetometer), a storage (e.g., a volatile memory, a non-volatile memory, etc.) and/or a communicator (e.g., a Wi-Fi module, a Bluetooth Low Energy (BLE) module, a Bluetooth module, etc.). The motion sensor can be used to sense the movement of the host device 11 or the peripheral device 13 to generate motion data correspondingly, in which the motion data can be used to calculate the position and/or orientation of the host device 11 or the peripheral device 13 by some mathematical calculations (e.g., integration, orthogonal decomposition, etc.). The storage can be used to store signals, data and/or information, such as the motion data, the images captured by the camera 112 or the camera 132, the map data HM, the position and/or orientation of at least one of the host device 11, the peripheral device 13 and the player device 10, etc. The host device 11 and the peripheral device 13 can use the communicator to communicate with each other or with other devices (e.g., transferring signals, data and/or information). Also, the host device 11 can further include a display panel, which can be implemented by an active matrix organic light emitting diode (AMOLED) display, organic light emitting diode (OLED) display, etc. The display panel can be used to display the at least one visual content generated by the processor 110, so that the host device 11 can provide the visual feedback (e.g., the immersive environment) for the user U1.

In some embodiments, when the peripheral device 13 is attached to the player device 10, the peripheral device 13 is configured to generate the position and/or orientation of the player device 10 relative to the peripheral device 13 attached to the player device 10. Based on the position and/or orientation of the player device 10 relative to the peripheral device 13 attached to the player device 10 as well as the position and/or orientation of the peripheral device 13 in the map data HM, the host device 11 can accurately display a virtual player device (i.e., the virtual object corresponding to the player device 10) in the immersive environment, so that the user U1's visual perception of the virtual player device matches the user U1's tactile perception of the player device 10.

Furthermore, when the user U1 operates the player device 10 where the peripheral device 13 is attached to interact with the at least one virtual object in the immersive environment, at least one of the host device 11 and the peripheral device 13 is configured to verify the position and/or orientation of the player device 10 relative to the peripheral device 13 attached to the player device 10, and is configured to, in response to the failed verification, update the position and/or orientation of the player device 10 relative to the peripheral device 13 attached to the player device 10, to avoid the mismatch between the user U1's visual perception of the virtual player device and the user U1's tactile perception of the player device 10.

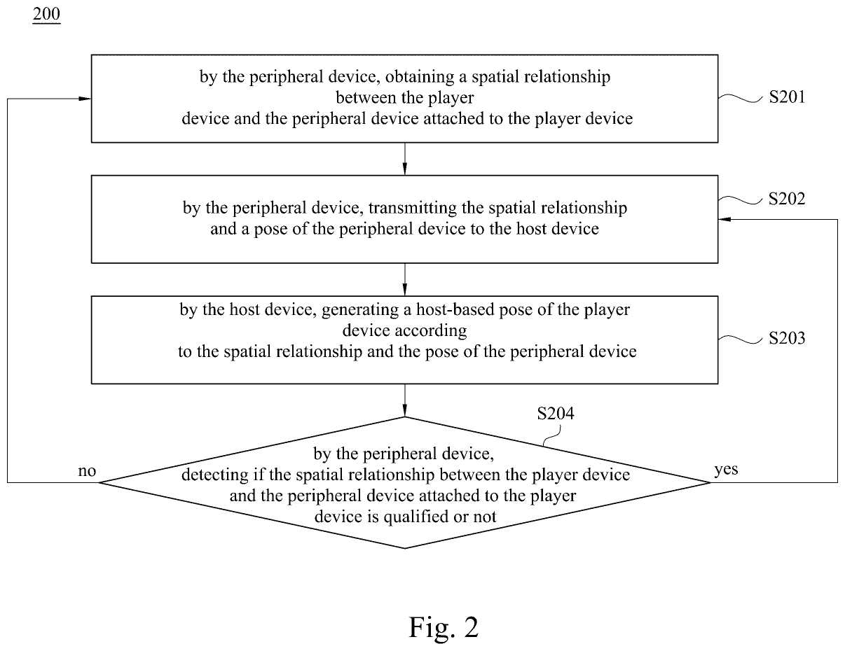

The above operations of the host device 11 and the peripheral device 13 of the multi-device system 100 would be further described below with reference to FIG. 2. FIG. 2 is a flow diagram of a tracking method 200 applicable to the multi-device system 100 in accordance with some embodiments of the present disclosure. In some embodiments, the multi-device system 100 executing the tracking method 200 can achieve a well match between the user U1's visual perception of the virtual player device and the user U1's tactile perception of the player device 10. As shown in FIG. 2, the tracking method 200 includes operations S201-S204. However, the present disclosure should not be limited thereto.

In some embodiments, before operation S201, the peripheral device 13 receives the map data HM established by the host device 11, so that the peripheral device 13 would be operated in the same spatial coordinate system as the host device 11.

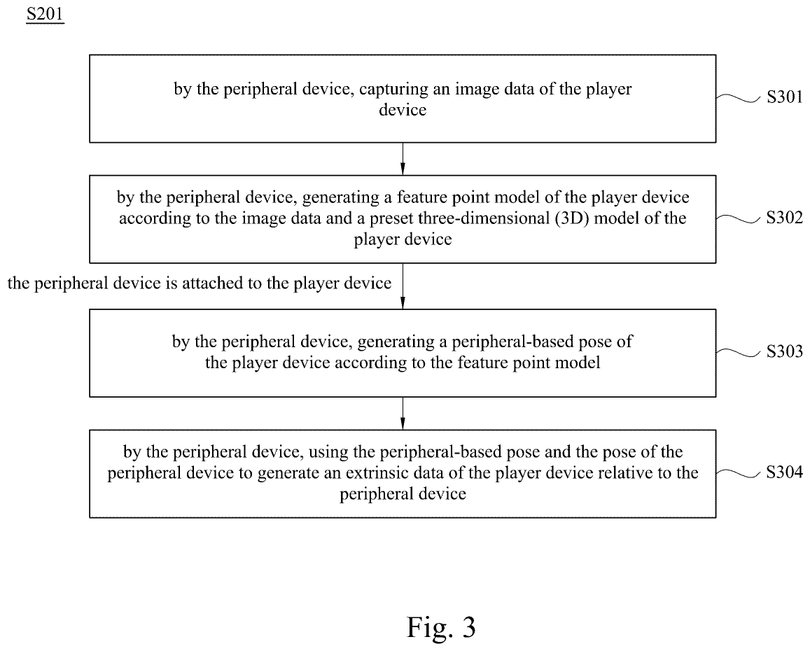

In operation S201, the peripheral device 13 obtains a spatial relationship between the player device 10 and the peripheral device 13 attached to the player device 10. In some embodiments, the peripheral device 13, by the processor 130 using the feature extraction based localization technologies and/or the interaction-based tracking technologies, calculates the position and/or orientation of the player device 10 relative to the peripheral device 13 when the peripheral device 13 is attached to the player device 10. In particular, the position and/or orientation of the player device 10 relative to the peripheral device 13 when the peripheral device 13 is attached to the player device 10 can be directly used as the spatial relationship between the player device 10 and the peripheral device 13 attached to the player device 10. These embodiments of operation S201 would be described later in detail with reference to FIGS. 3, 4A-4B, 5 and 6.

In operation S202, the peripheral device 13 transmits the spatial relationship and a pose PPE of the peripheral device 13 to the host device 11. In some embodiments, when the peripheral device 13 is attached to the player device 10, the peripheral device 13, by the processor 130 using the feature extraction based localization technologies, calculates the spatial coordinate or the position and/or orientation of the peripheral device 13 in the map data HM as the pose PPE. The peripheral device 13 can transmit the spatial relationship obtained in operation S201 and the pose PPE by its communicator, and the host device 11 can receive the spatial relationship obtained in operation S201 and the pose PPE by its communicator.

In operation S203, the host device 11 generates a host-based pose of the player device 10 according to the spatial relationship and the pose PPE of the peripheral device 13. In some embodiments, the pose PPE indicates the position and/or orientation of the peripheral device 13 attached to the player device 10 in the map data HM, and the spatial relationship transmitted to the host device 11 in operation S202 (or obtained in operation S201) indicates the position and/or orientation of the player device 10 relative to the peripheral device 13 when the peripheral device 13 is attached to the player device 10. Accordingly, when the peripheral device 13 is attached to the player device 10, the host device 11, by the processor 110, can use the spatial relationship and the pose PPE transmitted from the peripheral device 13 in operation S202 to calculate the spatial coordinate or the position and/or orientation of the player device 10 in the map data HM as the host-based pose. Furthermore, by the host-based pose of the player device 10, the host device 11 can display the virtual player device with the accurate position and/or orientation in the immersive environment, so as to provide the user U1 the visual perception matching the user U1's tactile perception of the player device 10.

In some embodiments, when the user U1 operates the player device 10 where the peripheral device 13 is attached in the physical environment E1, the peripheral device 13 attached to the player device 10 is possibly misaligned with the player device 10 due to physical decay or physical impact. In this case, the spatial relationship transmitted to the host device 11 in operation S202 may differ from the position and/or orientation of the player device 10 relative to the misaligned peripheral device 13 (i.e., a current spatial relationship between the player device 10 and the misaligned peripheral device 13 attached to the player device 10). The significant difference between those two relationships can result in the mismatch between the user U1's visual perception of the virtual player device and the user U1's tactile perception of the player device 10. Accordingly, operation S204 can be executed to verify the spatial relationship being currently used by the host device 11 and the peripheral device 13.

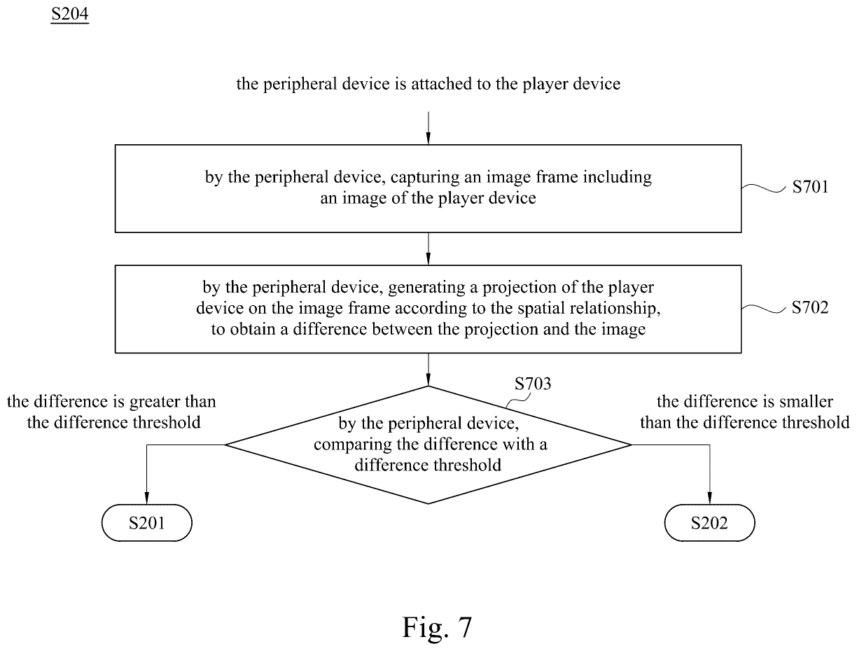

In operation S204, the peripheral device 13 detects if the spatial relationship between the player device 10 and the peripheral device 13 attached to the player device 10 is qualified or not. In some embodiments, the peripheral device 13 verifies the spatial relationship transmitted to the host device 11 in operation S202 by the processor 130 analyzing at least one image related to the player device 10 according to the spatial relationship transmitted to the host device 11 in operation S202, which would be described later in detail with reference to FIGS. 7-10. In particular, the at least one image related to the player device 10 is captured by the camera 132 when the peripheral device 13 is attached to the player device 10.

In some embodiments, when the peripheral device 13 is misaligned, the verification of the spatial relationship in operation S204 may be a failure (i.e., the spatial relationship between the player device 10 and the peripheral device 13 attached to the player device 10 is not qualified), so that, as shown in FIG. 2, operation S201 is executed again. That is to say, a new spatial relationship between the player device 10 and the peripheral device 13 attached to the player device 10 will be generated. Also, when the peripheral device 13 is not misaligned, the verification of the spatial relationship in operation S204 may be a success (i.e., the spatial relationship between the player device 10 and the peripheral device 13 attached to the player device 10 is qualified), so that, as shown in FIG. 2, operation S202 is executed again. That is to say, the spatial relationship between the player device 10 and the peripheral device 13 attached to the player device 10 is not updated and is continued to be used.

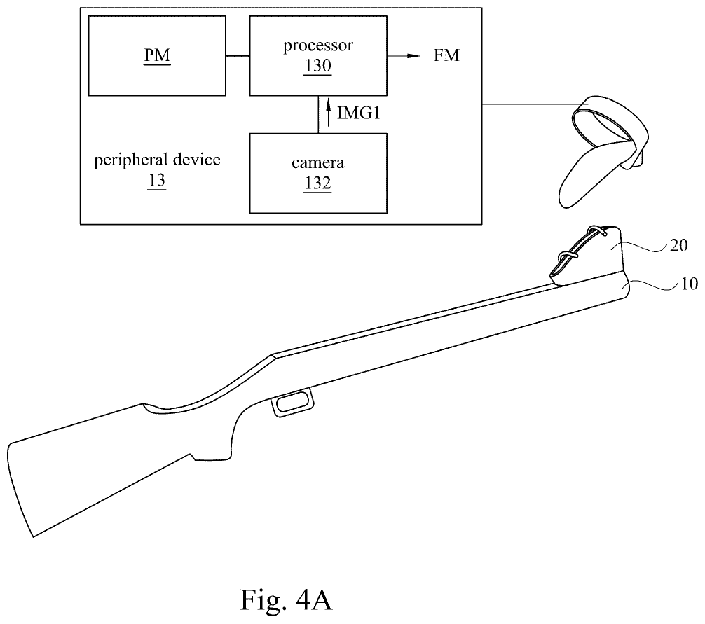

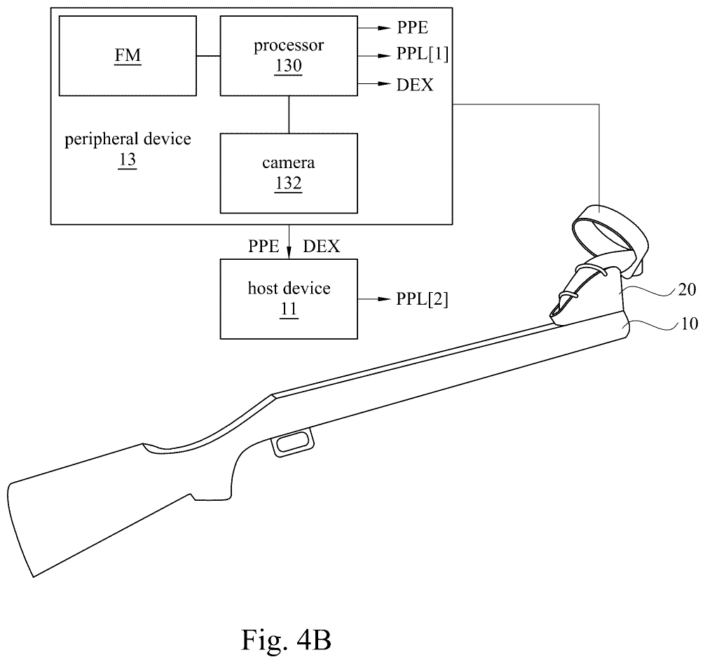

The details of operation S201 would be described in detail below with reference to FIGS. 3 and 4A-4B together. FIG. 3 is a flow diagram of operation S201 of the tracking method 200 in accordance with some embodiments of the present disclosure. FIGS. 4A and 4B are schematic diagrams of a procedure for obtaining the spatial relationship between the player device 10 and the peripheral device 13 attached to the player device 10 in accordance with some embodiments of the present disclosure. In some embodiments, as shown in FIG. 3, operation S201 includes sub-operations S301-S304.

In some embodiments, sub-operations S301-S302 are executed while the peripheral device 13 is not yet mounted on the player device 10. Specifically, before sub-operation S301, the user U1 may attempt to mount the peripheral device 13 into the connection device 20 disposed on the player device 10, and check whether the field of view of the camera 132 covers at least a portion of the player device 10 while the peripheral device 13 is mounted in the connection device 20. If not, the user U1 adjusts the connection device 20 to ensure that the field of view of the camera 132 covers at least a portion of the player device 10 while the peripheral device 13 is mounted in the connection device 20. If yes, the user U1 removes the peripheral device 13 from the connection device 20, and places the player device 10 on a steady place (e.g., a desk or support equipment) in the physical environment E1. When placing the player device 10, the user U1 should ensure that the observable area of the player device 10 is as exposed as possible and not obstructed (e.g., placing the gun-shaped device upright on the desk). Then, sub-operation S301 may be executed while the peripheral device 13 is held near the player device 10 on the steady place.

In sub-operation S301, the peripheral device 13 captures an image data IMG1 of the player device 10. In some embodiments, as shown in FIG. 4A, the peripheral device 13 held by the user U1 uses the camera 132 to capture the images of the player device 10 as the image data IMG1. Thus, it should be understood that the image data IMG1 may include at least one or a series of images (which may be taken from different angles, thereby composing the image data IMG1 with multi-angle information).

In sub-operation S302, the peripheral device 13 generates a feature point model FM of the player device 10 according to the image data IMG1 and a preset three-dimensional (3D) model PM of the player device 10. In particular, the preset 3D model PM is stored in the storage of the peripheral device 13, and records an actual or physical appearance of the player device 10. In the embodiments of FIG. 4A, by the processor 130 using the feature extraction based localization technologies, the peripheral device 13 extracts multiple feature points from at least one image of the player device 10 in the image data IMG1, and matches these feature points to multiple map points of the map data HM, to obtain some feature points matching the map points as a feature point data of the player device 10. It should be understood that each feature point in the feature point data has a descriptor indicating one spatial coordinate in the map data HM at least, so that the distribution of the feature point data presents an approximate appearance of the player device 10. Accordingly, the processor 130 can map the feature point data to the preset 3D model PM by fitting the approximate appearance of the player device 10 to the physical appearance of the player device 10, to form the feature point model FM. That is to say, each feature point in the feature point model FM of the player device 10 is linked to a corresponding part of the preset 3D model PM, and therefore each part of the player device 10 can be accurately localized in the map data HM (or the physical environment E1) according to the feature point model FM of the player device 10.

After the feature point model FM is generated, the peripheral device 13 can be mounted by the user U1 in the connection device 20. That is to say, as shown in FIG. 4B, the peripheral device 13 is attached to the player device 10 through the connection device 20. Accordingly, sub-operations S303-S304 are executed.

As shown in FIG. 3, in sub-operation S303, the peripheral device 13 generates a peripheral-based pose of the player device 10 according to the feature point model FM. In the embodiments of FIG. 4B, the processor 130, which using the feature extraction based localization technologies, may receive at least one image captured by the camera 132 when the peripheral device 13 is attached to the player device 10, and may selectively update the corresponding spatial coordinate of each feature point in the feature point model FM by analyzing the at least one image (e.g., performing the feature extraction to the at least one image). In particular, because the feature point model FM is generated when the player device 10 is placed on the steady place, the feature point model FM can be updated in response to the displacement of the player device 10 from the steady place. Afterwards, as shown in FIG. 4B, the processor 130 calculates the position and/or orientation of the player device 10 in the map data HM according to the feature point model FM as a pose PPL[1] of the player device 10 (i.e., the peripheral-based pose).

As shown in FIG. 3 again, in sub-operation S304, the peripheral device 13 uses the peripheral-based pose and the pose PPE of the peripheral device 13 to generate an extrinsic data DEX of the player device 10 relative to the peripheral device 13. In the embodiments of FIG. 4B, the pose PPE may also be updated by the processor 130 using the feature extraction based localization technologies in response to the displacement of the player device 10 from the steady place, so that the pose PPE indicates the instant position and/or orientation of the peripheral device 13 in the map data HM when the peripheral device 13 is attached to the player device 10. Accordingly, the peripheral device 13, by the processor 130, can use the pose PPL[1] of the player device 10 and the pose PPE of the peripheral device 13 to calculate the position and/or orientation of the player device 10 relative to the peripheral device 13 attached to the player device 10 as the extrinsic data DEX. In particular, the extrinsic data DEX can be used as the spatial relationship obtained in operation S201.

The present disclosure does not intend to limit operation S201 to the embodiments of FIGS. 3 and 4A-4B. For example, in some further embodiments of FIGS. 3 and 4A-4B, after sub-operation S302 or before the peripheral device 13 is attached to the player device 10, the peripheral device 13 further determines if an amount of feature points covering or on a preset portion of the preset 3D model PM is greater than an amount threshold. In particular, the preset portion of the preset 3D model PM can be corresponding to a handheld portion of the player device 10 (e.g., a handle grip of the rifle). By the peripheral device 13 ensuring the amount of feature points on the preset portion of the preset 3D model PM being greater than the amount threshold, the position and/or orientation of the handheld portion of the player device 10 in the map data HM calculated according to a feature point set of the feature point model FM (which is corresponding to the preset portion) should be reliable, such that a virtual handheld portion of the virtual player device (which is corresponding to the handheld portion of the player device 10) can be accurately displayed in the immersive environment, which provides the user U1 the visual perception matching the user U1's tactile perception of holding the handheld portion of the player device 10.

Based on the above descriptions, in some embodiments, when the amount of feature points on the preset portion of the preset 3D model PM is greater than the amount threshold, the peripheral device 13 can notify the user U1 that the peripheral device 13 is ready to be attached to the player device 10, so as to execute sub-operations S303-S304. Also, when the amount of feature points on the preset portion of the preset 3D model PM is not greater than the amount threshold, the peripheral device 13 can notify the user U1 to move the peripheral device 13 closer to the handheld portion of the player device 10, or to adjust the placement of the player device 10, so as to execute sub-operations S301-S302 again. In other words, the peripheral device 13 can re-generate the feature point model FM, to ensure there are enough feature points on the preset portion of the preset 3D model PM.

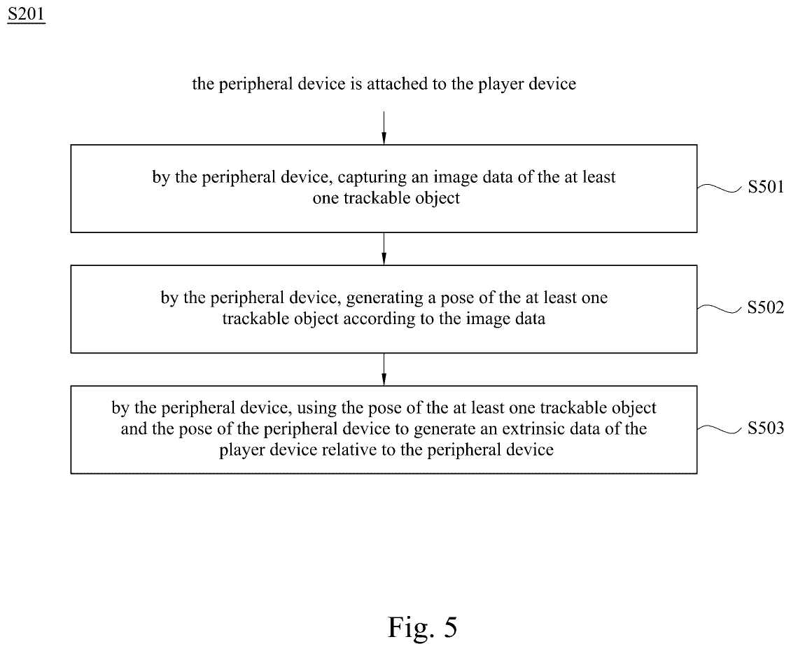

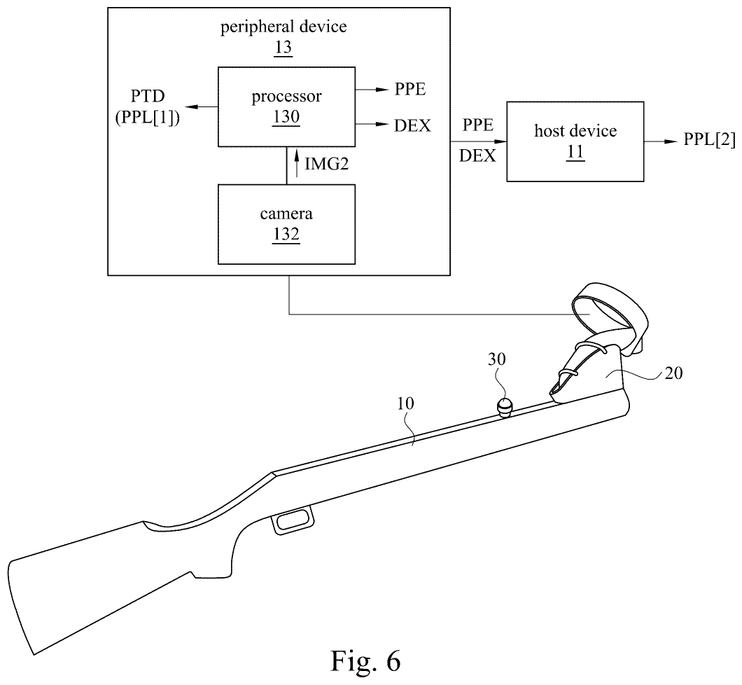

The details of operation S201 would be also described in detail below with reference to FIGS. 5 and 6 together. FIG. 5 is a flow diagram of operation S201 of the tracking method 200 in accordance with some embodiments of the present disclosure. FIG. 6 is a schematic diagram of a procedure for obtaining the spatial relationship between the player device 10 and the peripheral device 13 attached to the player device 10 in accordance with some embodiments of the present disclosure. In some embodiments, as shown in FIG. 5, operation S201 includes sub-operations S501-S503.

In some embodiments, as shown in FIG. 6, the player device 10 is provided with at least one trackable object 30. In particular, the trackable object 30 is disposed on an external surface of the player device 10 to be directly captured by the camera 132 of the peripheral device 13, and can be implemented by one or more light emitters (e.g., a light emitting diode (LED), a laser diode (LD), etc.), one or more markers with a preset shape or pattern, etc. In comparison to the embodiments of FIGS. 3 and 4A-4B, in the embodiments of FIG. 6, the peripheral device 13 is configured to interact with the trackable object 30 to obtain the spatial relationship between the player device 10 and the peripheral device 13 attached to the player device 10 instead of generating the feature point model FM of the player device 10. Thus, the peripheral device 13 can directly notify the user U1 of mounting the peripheral device 13 in the connection device 20, so as to execute sub-operations S501-S503. That is, as shown in FIG. 5, sub-operations S501-S503 are executed when the peripheral device 13 is attached to the player device 10. It should be understood that, before sub-operation S501, the user U1 can further check if the field of view of the camera 132 covers the at least one trackable object 30 while the peripheral device 13 is mounted in the connection device 20.

In sub-operation S501, the peripheral device 13 captures an image data IMG2 of the at least one trackable object 30. In some embodiments, as shown in FIG. 6, the peripheral device 13 attached to the player device 10 uses the camera 132 to capture the images of the trackable object 30 as the image data IMG2. Thus, it should be understood that the image data IMG2 may include at least one or a series of images.

In sub-operation S502, the peripheral device 13 generates a pose PTD of the at least one trackable object 30 according to the image data IMG2. In the embodiments of FIG. 6, the processor 130, which using the interaction-based tracking technologies, may receive the image data IMG2 captured by the camera 132 when the peripheral device 13 is attached to the player device 10, and may recognize at least one image of the trackable object 30 in the image data IMG2. Afterwards, as shown in FIG. 6, the processor 130 can calculate the pose PTD of the trackable object 30 (i.e., the position and/or orientation of the trackable object 30 in the map data HM) according to the at least one image of the trackable object 30.

In sub-operation S503, the peripheral device 13 uses the pose PTD of the at least one trackable object 30 and the pose PPE of the peripheral device 13 to generate an extrinsic data DEX of the player device 10 relative to the peripheral device 13. In the embodiments of FIG. 6, the pose PTD of the trackable object 30 can be directly used to represent the pose PPL[1] of the player device 10 (i.e., the position and/or orientation of the player device 10 in the map data HM). Also, the pose PPE may be updated by the processor 130 using the feature extraction based localization technologies to indicate the instant position and/or orientation of the peripheral device 13 in the map data HM when the peripheral device 13 is attached to the player device 10. Accordingly, the peripheral device 13, by the processor 130, can use the pose PTD of the trackable object 30 and the pose PPE of the peripheral device 13 to calculate the position and/or orientation of the player device 10 relative to the peripheral device 13 attached to the player device 10 as the extrinsic data DEX. In particular, the extrinsic data DEX can be used as the spatial relationship obtained in operation S201.

In the above embodiments of operation S201 (i.e., the embodiments of FIGS. 3, 4A-4B, 5 and 6), when the extrinsic data DEX is generated, the peripheral device 13, by the camera 132, can further capture one image (not shown) as a reference image. That is, this reference image has a timestamp corresponding to a time point when the extrinsic data DEX is generated, and can be stored to re-obtain the extrinsic data DEX thereafter. In brief, every time the spatial relationship between the player device 10 and the peripheral device 13 attached to the player device 10 is obtained in operation S201 one corresponding reference image will be recorded or stored by the peripheral device 13.

In some embodiments of operation S202, as shown in FIG. 4B or 6, the peripheral device 13, by the communicator, transmits the extrinsic data DEX and the pose PPE of the peripheral device 13 to the host device 11, so that operation S203 can be executed. In some embodiments of operation S203, as shown in FIG. 4B or 6, the host device 11 can use the extrinsic data DEX to transform the pose PPE of the peripheral device 13 into a pose PPL[2] of the player device 10 (i.e., the host-based pose of the player device 10). In particular, the pose PPL[2] indicates the spatial coordinate or the position and/or orientation of the player device 10 in the map data HM. From the descriptions of operation S201-S203, it can be seen that the pose PPE of the peripheral device 13, the extrinsic data DEX, the pose PTD of the trackable object 30, the pose PPL[1] of the player device 10 and the pose PPL[2] of the player device 10 are defined in the spatial coordinate system of the map data HM established by the host device 11.

The details of operation S204 would be described in detail below with reference to FIG. 7. FIG. 7 is a flow diagram of operation S204 of the tracking method 200 in accordance with some embodiments of the present disclosure. In some embodiments, as shown in FIG. 7, operation S204 includes sub-operations S701-S703. In accordance with the above descriptions of operation S204, operation S204 is executed when the user U1 operates the player device 10 where the peripheral device 13 is attached, to verify the spatial relationship being currently used. Thus, sub-operations S701-S703 are executed when the peripheral device 13 is attached to the player device 10.

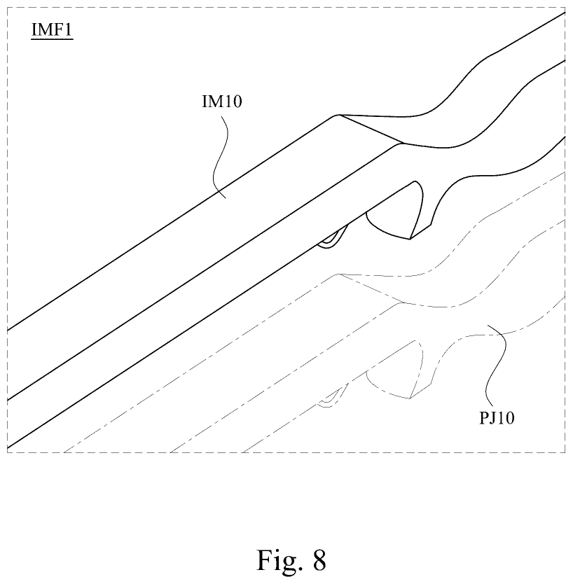

In sub-operation S701, the peripheral device 13 captures an image frame IMF1 including an image IM10 of the player device 10. Referring to FIG. 8, FIG. 8 is a schematic diagram of the image frame IMF1 captured by the peripheral device 13 in accordance with some embodiments of the present disclosure. In some embodiments, because the peripheral device 13 is closely attached to the player device 10, the field of view of the camera 132 is fixed in relation to the player device 10, and usually covers only part of the player device 10. Thus, in FIG. 8, the image IM10 of the player device 10 is corresponding to the part of the player device 10. It should be understood that the image IM10 of the player device 10 will be fixed in relation to the image frame IMF1 when the peripheral device 13 attached to the player device 10 is not misaligned with the player device 10. That is, the position of the image IM10 on the image frame IMF1 will be fixed.

In sub-operation S702, the peripheral device 13 generates a projection PJ10 of the player device 10 on the image frame IMF1 according to the spatial relationship, to obtain a difference between the projection PJ10 and the image IM10. In accordance with the above descriptions related to the reference image, the extrinsic data DEX can be re-obtained by analyzing the reference image (e.g., performing the feature extraction to the reference image). On the other hand, the position and/or orientation of the player device 10 relative to the peripheral device 13 when the reference image or the extrinsic data DEX is generated can also be generated by calculating according to the extrinsic data DEX. Accordingly, in some embodiments, the peripheral device 13, by the processor 130 calculating according to the extrinsic data DEX (i.e., the spatial relationship), projects the player device 10 with the position and/or orientation recorded or indicated by the reference image onto the image frame IMF1, to generate the projection PJ10 of the player device 10 on the image frame IMF1.

Then, in some embodiments, the peripheral device 13, by the processor 130, calculates a pixel shift from the projection PJ10 of the player device 10 to the image IM10 in the image frame IMF1 as the difference between the projection PJ10 and the image IM10 in the image frame IMF1. For example, the pixel shift can be defined by a translation distance from one pixel point of the projection PJ10 to a corresponding one pixel point of the image IM10 in the image frame IMF1. The one pixel point of the projection PJ10 and the corresponding one pixel point of the image IM10 both may correspond to the same point on the player device 10.

In sub-operation S703, the peripheral device 13 compares the difference with a difference threshold. In particular, the difference threshold can be a pixel length (e.g., 5 pixels). In some embodiments, the peripheral device 13, by the processor 130, performs a comparison between the pixel shift and the pixel length to determine if the difference is greater than the difference threshold. The processor 130 determines the difference is greater than the difference threshold when the pixel shift exceeds the pixel length, which means the verification of the recorded or stored spatial relationship (i.e., the extrinsic data DEX) is failed. Accordingly, as shown in FIG. 7, operation S201 will be executed to update the extrinsic data DEX. The processor 130 determines the difference is smaller than the difference threshold when the pixel shift does not exceed the pixel length, which means the verification of the recorded or stored spatial relationship is successful. Accordingly, as shown in FIG. 7, operation S202 will be executed to not update the extrinsic data DEX.

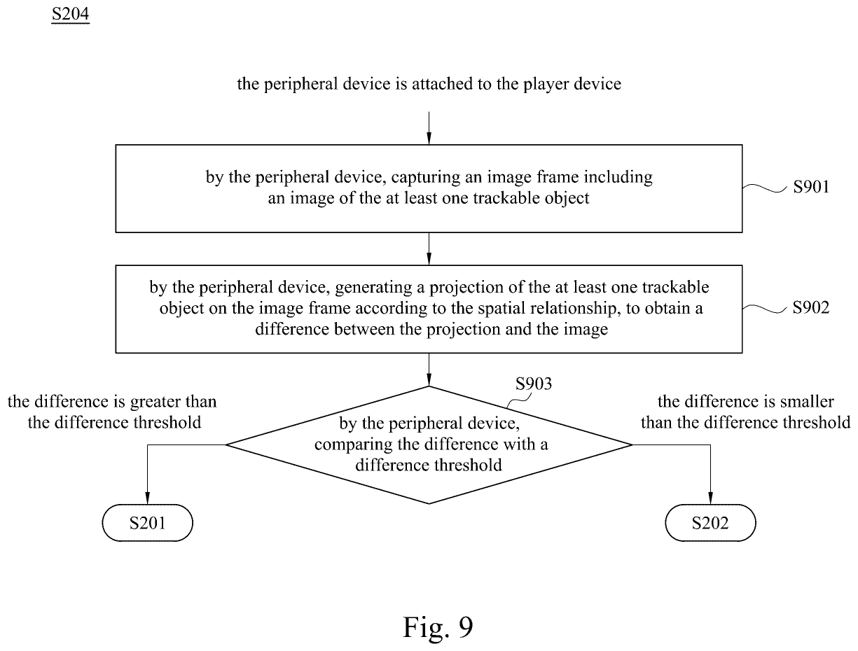

The details of operation S204 would be also described in detail below with reference to FIG. 9. FIG. 9 is a flow diagram of operation S204 of the tracking method 200 in accordance with some embodiments of the present disclosure. In some embodiments, as shown in FIG. 9, operation S204 includes sub-operations S901-S903. As the above descriptions of FIG. 7, sub-operations S901-S903 are also executed when the peripheral device 13 is attached to the player device 10, to verify the spatial relationship being currently used.

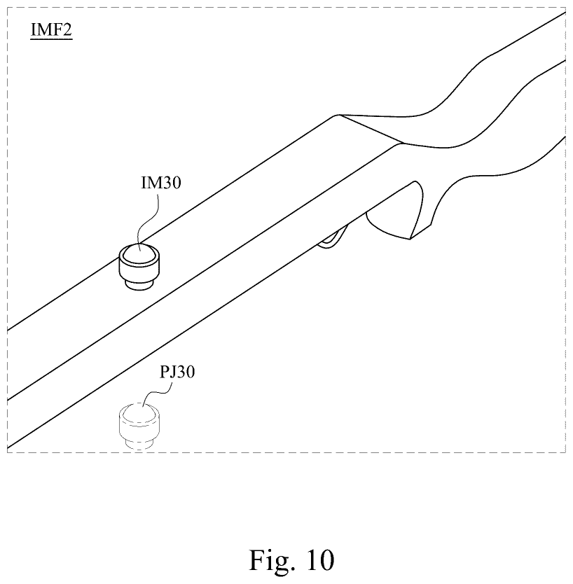

In sub-operation S901, the peripheral device 13 captures an image frame IMF2 including an image IM30 of the at least one trackable object 30. Referring to FIG. 10, FIG. 10 is a schematic diagram of the image frame IMF2 captured by the peripheral device 13 in accordance with some embodiments of the present disclosure. As the above descriptions of FIG. 8, in the image frame IMF2 of FIG. 10, there will be the image of the player device 10 corresponding to the part of the player device 10 covered by the field of view of the camera 132. Furthermore, the embodiments of FIG. 10 are corresponding to the embodiments of FIG. 6, and thus in the image frame IMF2 of FIG. 10, there is also the image IM30 of the trackable object 30 which is disposed on the player device 10.

In sub-operation S902, the peripheral device 13 generates a projection PJ30 of the at least one trackable object 30 on the image frame IMF2 according to the spatial relationship, to obtain a difference between the projection PJ30 and the image IM30. In the embodiments of FIG. 6, the spatial relationship (i.e., the extrinsic data DEX) is obtained according to the trackable object 30 disposed on the player device 10, and thus can be re-obtained from the corresponding reference image recording the position and/or orientation of the trackable object 30 relative to the peripheral device 13 when the extrinsic data DEX is generated. As the above descriptions of sub-operation S702, in some embodiments, the peripheral device 13, by the processor 130 calculating according to the extrinsic data DEX (i.e., the spatial relationship), projects the trackable object 30 with the position and/or orientation recorded or indicated by the reference image onto the image frame IMF2, to generate the projection PJ30 of the trackable object 30 on the image frame IMF2. Also, the peripheral device 13, by the processor 130, calculates a pixel shift from the projection PJ30 of the trackable object 30 to the image IM30 in the image frame IMF2 (e.g., a translation distance from one pixel point of the projection PJ30 to a corresponding one pixel point of the image IM30 in the image frame IMF2) as the difference between the projection PJ30 and the image IM30 in the image frame IMF2.

In sub-operation S903, the peripheral device 13 compares the difference with a difference threshold. As the above descriptions of sub-operation S703, in some embodiments, the peripheral device 13, by the processor 130, performs a comparison between the pixel shift and the pixel length to determine if the difference is greater than the difference threshold. In particular, as shown in FIG. 9, operation S201 will be executed when the difference is greater than the difference threshold (i.e., when the pixel shift exceeds the pixel length), and operation S202 will be executed when the difference is smaller than the difference threshold (i.e., when the pixel shift does not exceed the pixel length).

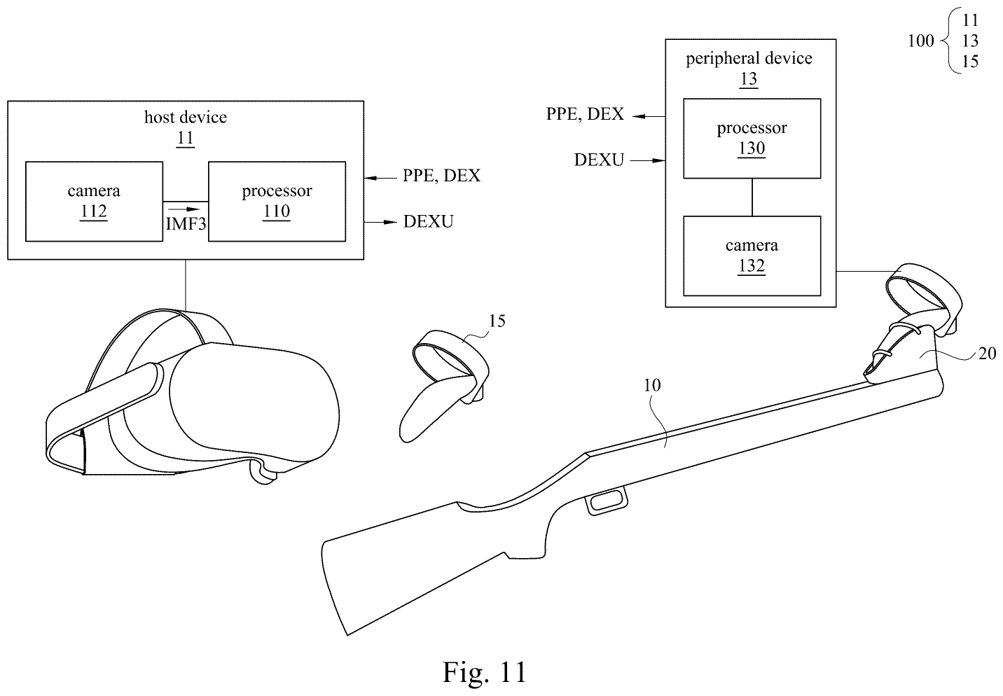

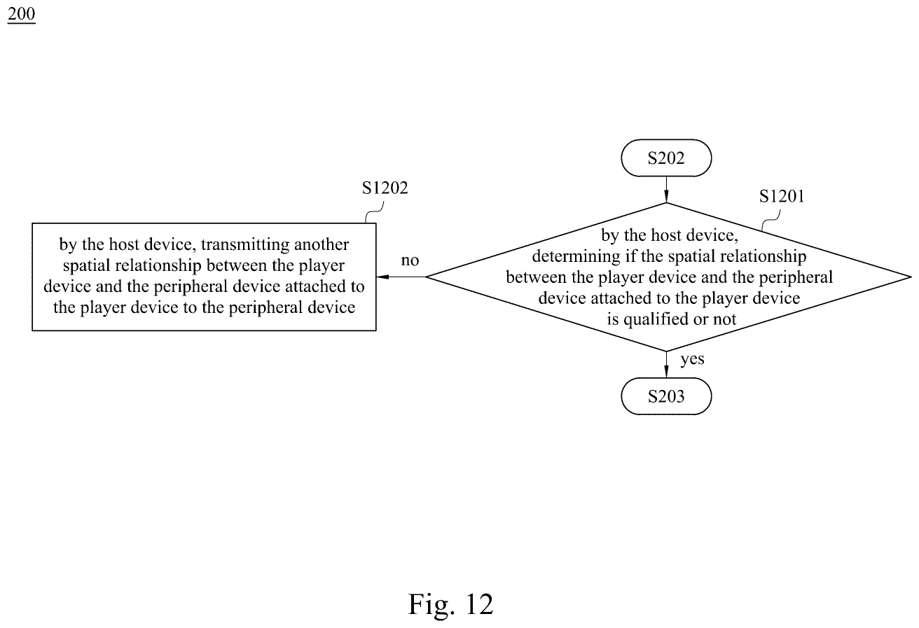

The present disclosure does not intend to limit the tracking method 200 to the flow diagram of FIG. 2 and/or to limit the multi-device system 100 to the device combination as shown in FIG. 1. Referring to FIG. 11, FIG. 11 is a schematic diagram of the multi-device system 100 in accordance with some embodiments of the present disclosure. In some embodiments, as shown in FIG. 11, the multi-device system 100 further includes another peripheral device 15. The configurations of the peripheral device 15 are similar or the same as those of the peripheral device 13, and therefore are not described herein. In some embodiments, the verification of the spatial relationship obtained in operation S201 can be performed by the host device 11 or the peripheral device 15, which would be described in detail below with reference to FIG. 12. FIG. 12 is a flow diagram of the tracking method 200 in accordance with some embodiments of the present disclosure. In some embodiments, as shown in FIG. 12, the tracking method 200 further includes operations S1201 and S1202, and operation S1201 is executed after operation S202. That is, operation S1201 is executed after the host device 11 receives the spatial relationship obtained in operation S201 and the pose PPE from the peripheral device 13. As mentioned earlier, in some embodiments, the host device 11 may be replaced by the another peripheral device 15 in the multiple subsequent sub-operations.

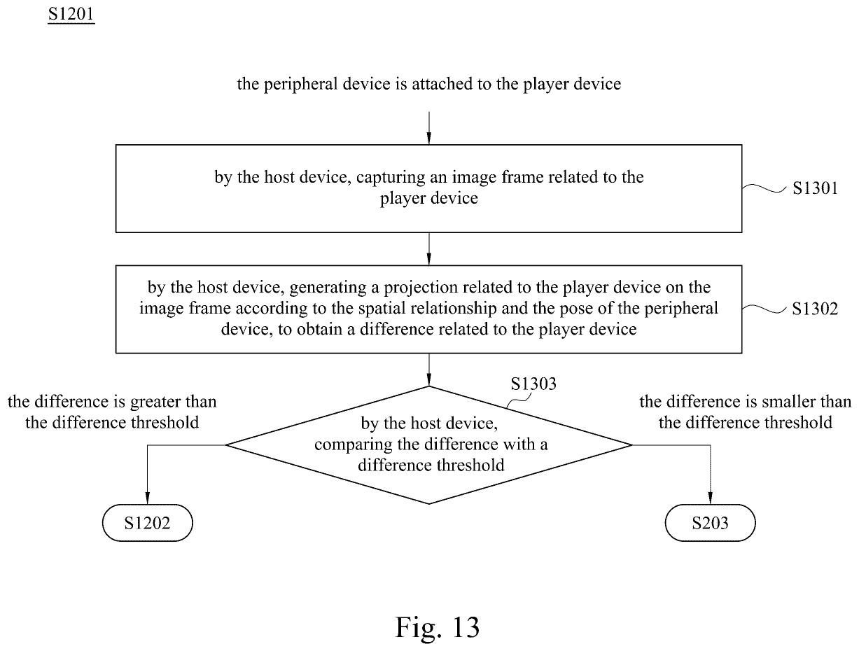

In operation S1201, the host device 11 determines if the spatial relationship between the player device 10 and the peripheral device 13 attached to the player device 10 is qualified or not, which would be described in detail below with reference to FIG. 13. FIG. 13 is a flow diagram of operation S1201 of the tracking method 200 in accordance with some embodiments of the present disclosure. In some embodiments, as shown in FIG. 13, operation S1201 includes sub-operations S1301-S1303. As the above descriptions of operation S204, sub-operations S1301-S1303 are also executed when the peripheral device 13 is attached to the player device 10, to verify the spatial relationship being currently used.

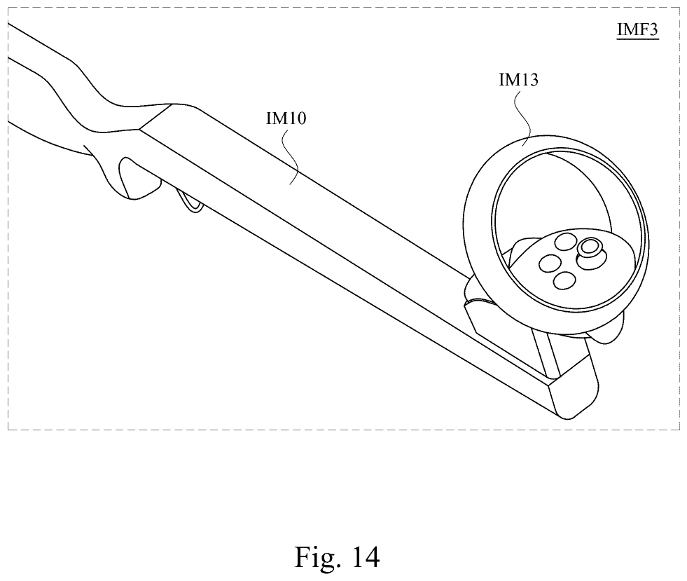

In sub-operation S1301, the host device 11 captures an image frame IMF3 related to the player device 10. Referring to FIG. 14, FIG. 14 is a schematic diagram of the image frame IMF3 captured by the host device 11 in accordance with some embodiments of the present disclosure. In some embodiments, because the host device 11 worn on the head of the user U1 is usually further away from the player device 10 than the peripheral device 13, a field of view of the camera 112 can cover both the whole or partial player device 10 and the whole or partial peripheral device 13. Thus, in FIG. 14, the image frame IMF3 captured by the camera 112 of the host device 11 includes the image IM10 of the player device 10 and an image IM13 of the peripheral device 13 attached to the player device 10.

In sub-operation S1302, the host device 11 generates a projection (not shown) related to the player device 10 on the image frame IMF3 according to the spatial relationship and the pose PPE of the peripheral device 13, to obtain a difference related to the player device 10. In the embodiments of FIG. 11, the host device 11, by the processor 110, uses the position and/or orientation of the player device 10 recorded in the reference image (which can be calculated according to the extrinsic data DEX (i.e., the spatial relationship)) and the pose PPE to generate an reference extrinsic information (not shown) of the player device 10 relative to the host device 11. In particular, the reference extrinsic information indicates the position and/or orientation of the player device 10 relative to the host device 11 when the reference image or the extrinsic data DEX is generated. The host device 11, by the processor 110 calculating according to the reference extrinsic information, projects the player device 10 with the position and/or orientation indicated by the reference extrinsic information onto the image frame IMF3, to generate the projection related to the player device 10. Also, the host device 11, by the processor 110, calculates a pixel shift from the projection related to the player device 10 to the image IM10 in the image frame IMF3 (e.g., a translation distance from one pixel point of the projection related to the player device 10 to a corresponding one pixel point of the image IM10 in the image frame IMF3) as the difference related to the player device 10.

In sub-operation S1303, the host device 11 compares the difference with a difference threshold. As the above descriptions of sub-operation S703 or S903, in some embodiments, the host device 11, by the processor 110, performs a comparison between the pixel shift and the pixel length to determine if the difference is greater than the difference threshold. In particular, as shown in FIG. 13, operation S1202 will be executed when the difference is greater than the difference threshold (i.e., when the pixel shift exceeds the pixel length), to allow the peripheral device 13 to update the spatial relationship being currently used. Also, operation S203 will be executed when the difference is smaller than the difference threshold (i.e., when the pixel shift does not exceed the pixel length), to display the virtual player device with the accurate position and/or orientation in the immersive environment according to the spatial relationship being currently used.

In some further embodiments of FIG. 13, when the peripheral device 13 is attached to the player device 10, and the player device 10 is placed on a steady place in the physical environment E1, and the distance between the host device 11 and the player device 10 does not exceed, for example 0.5 meters, sub-operations S1301-S1303 are executed. In such arrangements, because the spatial relationship (the extrinsic data DEX) and the pose PPE remain unchanged, the computation burden of the processor 110 of the host device 11 is reduced, such that the sub-operations S1301-S1303 can be executed more fluently.

Furthermore, the flow diagram of FIG. 13 is applicable to the embodiments where the player device 10 is provided with the trackable object 30. For example, the image frame IMF3 related to the player device 10 captured in sub-operation S1301 can further include the image IM30 of the trackable object 30. In sub-operation S1302, the projection related to the player device 10 can be generated by projecting the trackable object 30 with the position and orientation calculated according to the extrinsic data DEX and the pose PPE onto the image frame IMF3, and the difference related to the player device 10 is a pixel shift from the projection of the trackable object 30 to the image IM30 of the trackable object 30 in the image frame IMF3.

As shown in FIG. 12, in operation S1202, the host device 11 transmits another spatial relationship between the player device 10 and the peripheral device 13 attached to the player device 10 to the peripheral device 13. In some embodiments, before operation S1202, the host device 11, by the processor 110 using the feature extraction based localization technologies and/or the interaction-based tracking technologies, calculates the position and/or orientation of the player device 10 relative to the peripheral device 13 attached to the player device 10 as the another spatial relationship. In particular, as the descriptions of sub-operations S301-S303, the host device 11 can generate another feature point model (not shown) of the player device 10 according to the images of the player device 10 and the preset 3D model PM, and can generate a pose data (not shown) of the player device 10 according to the another feature point model. Also, as the descriptions of sub-operations S501 and 8502, the host device 11 can generate the pose data of the player device 10 by tracking the trackable object 30 according to the images of the trackable object 30. Then, the host device 11 can use the pose data of the player device 10 and the pose PPE, which is received from the peripheral device 13, to generate another extrinsic data DEXU of the player device 10 relative to the peripheral device 13. From these descriptions, it can be seen that the pose data of the player device 10 is generated by the host device 11 according to image information related to the player device 10, such as the images of the player device 10, the images of the trackable object 30 arranged on the player device 10, etc.

In some embodiments of operation S1202, as shown in FIG. 11, the host device 11 transmits the extrinsic data DEXU to the peripheral device 13 as the another spatial relationship, such that the peripheral device 13 can update the spatial relationship being currently used by the extrinsic data DEXU.

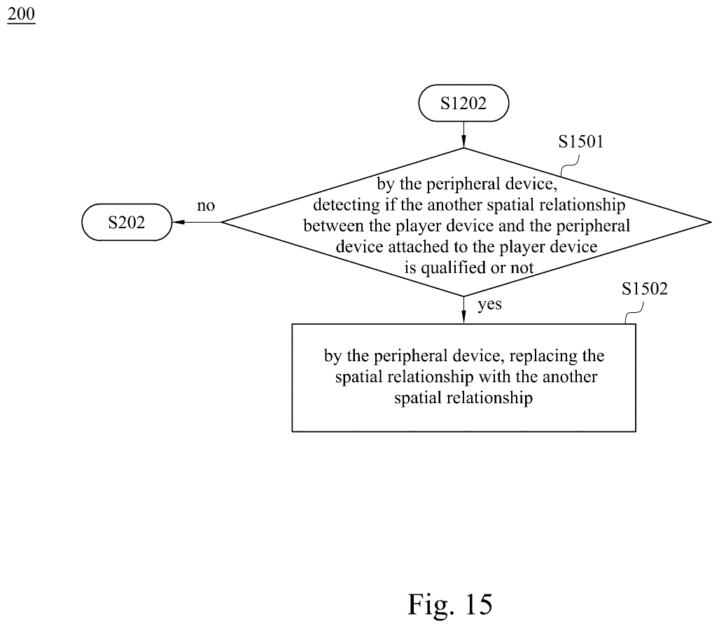

In some further embodiments, the peripheral device 13 can verify the another spatial relationship transmitted from the host device 11 instead of directly using the another spatial relationship, which will be described in detail below with reference to FIG. 15. FIG. 15 is a flow diagram of the tracking method 200 in accordance with some embodiments of the present disclosure.

In accordance with the embodiments of FIG. 13, as shown in FIG. 15, the tracking method 200 further includes operations S1501 and S1502, and operation S1501 will be executed after operation S1202. In operation S1501, the peripheral device 13 detects if the another spatial relationship between the player device 10 and the peripheral device 13 attached to the player device 10 is qualified or not. The detailed descriptions of operation S1501 are similar or the same as those of operation S204 in FIG. 7 or 9, and therefore are omitted herein.

In the embodiments of FIG. 15, when the peripheral device 13 detects that the another spatial relationship between the player device 10 and the peripheral device 13 attached to the player device 10 is qualified, operation S1502 will be executed. In operation S1502, the peripheral device 13 replaces the spatial relationship with the another spatial relationship. That is, the peripheral device 13 updates the spatial relationship being currently used. In particular, the peripheral device 13 replaces the extrinsic data DEX with the extrinsic data DEXU to update the spatial relationship being currently used. Also, when the peripheral device 13 detects that the another spatial relationship between the player device 10 and the peripheral device 13 attached to the player device 10 is not qualified, operation S202 will be executed. That is, the spatial relationship being currently used is continued to be used, and the another spatial relationship received from the host device 11 may be abandoned or not stored. However, the present disclosure is not limited herein. For example, when the peripheral device 13 detects that the another spatial relationship between the player device 10 and the peripheral device 13 attached to the player device 10 is not qualified, in some embodiments, operation S204 can also be executed, so that the spatial relationship being currently used can be further verified by the peripheral device 13.

As can be seen from the above embodiments of the present disclosure, by obtaining and/or verifying the spatial relationship between the player device 10 and the peripheral device 13 attached to the player device 10, the host device 11 can display the virtual player device corresponding to the player device 10 with the accurate position and/or orientation in the immersive environment, which provides the user U1 the visual perception matching the user U1's tactile perception of the player device 10. Moreover, any tracking device attachable to the player device 10 can be used to replace the peripheral device 13, and thus there is no need to newly design additional tracking modules for tracking the player device 10. In sum, the multi-device system 100 and the tracking method 200 of the present disclosure have advantages of cost saving, high compatibility, well user experience, etc.

The disclosed methods, may take the form of a program code (i.e., executable instructions) embodied in tangible media, such as floppy diskettes, CD-ROMS, hard drives, or any other transitory or non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A tracking method, applicable to a multi-device system, wherein the multi-device system is configured to track a player device in a physical environment and comprises a host device and a peripheral device, and the tracking method comprises:
by the peripheral device, obtaining a spatial relationship between the player device and the peripheral device attached to the player device;
by the peripheral device, transmitting the spatial relationship and a first pose of the peripheral device to the host device, wherein the first pose is generated by the peripheral device attached to the player device;
by the host device, generating a second pose of the player device according to the spatial relationship and the first pose, wherein the spatial relationship, the first pose and the second pose are defined in a spatial coordinate system; and
in response to a detection of the spatial relationship being unqualified, by the peripheral device, updating the spatial relationship between the player device and the peripheral device attached to the player device.

2. The tracking method of claim 1, wherein by the peripheral device, obtaining the spatial relationship between the player device and the peripheral device attached to the player device comprises:
by the peripheral device, capturing an image data of the player device;
by the peripheral device, generating a feature point model of the player device according to the image data and a preset three-dimensional (3D) model of the player device; and
when the peripheral device is attached to the player device, by the peripheral device, generating a third pose of the player device according to the feature point model, and using the third pose and the first pose to generate an extrinsic data of the player device relative to the peripheral device as the spatial relationship, wherein the third pose is defined in the spatial coordinate system.

3. The tracking method of claim 1, wherein the player device is provided with at least one trackable object, and by the peripheral device, obtaining the spatial relationship between the player device and the peripheral device attached to the player device comprises:
when the peripheral device is attached to the player device, by the peripheral device, generating a third pose of the at least one trackable object according to an image data of the at least one trackable object, and using the third pose and the first pose to generate an extrinsic data of the player device relative to the peripheral device as the spatial relationship, wherein the third pose is defined in the spatial coordinate system.

4. The tracking method of claim 1, further comprising:
by the peripheral device, detecting if the spatial relationship between the player device and the peripheral device attached to the player device is qualified or not, wherein the spatial relationship is not updated when the spatial relationship is qualified.

5. The tracking method of claim 4, wherein by the peripheral device, detecting if the spatial relationship between the player device and the peripheral device attached to the player device is qualified or not comprises:
when the peripheral device is attached to the player device, by the peripheral device, capturing an image frame comprising an image of the player device;
by the peripheral device, generating a projection of the player device on the image frame according to the spatial relationship, to obtain a difference between the projection and the image; and
by the peripheral device, comparing the difference with a difference threshold, wherein the spatial relationship is qualified when the difference is smaller than the difference threshold, and the spatial relationship is unqualified when the difference is greater than the difference threshold.

6. The tracking method of claim 4, wherein the player device is provided with at least one trackable object, and by the peripheral device, detecting if the spatial relationship between the player device and the peripheral device attached to the player device is qualified or not comprises:
when the peripheral device is attached to the player device, by the peripheral device, capturing an image frame comprising an image of the at least one trackable object;
by the peripheral device, generating a projection of the at least one trackable object on the image frame according to the spatial relationship, to obtain a difference between the projection and the image; and
by the peripheral device, comparing the difference with a difference threshold, wherein the spatial relationship is qualified when the difference is smaller than the difference threshold, and the spatial relationship is unqualified when the difference is greater than the difference threshold.

7. The tracking method of claim 1, further comprising:
by the host device or another peripheral device of the multi-device system, determining if the spatial relationship between the player device and the peripheral device attached to the player device is qualified or not; and
in response to a determination of the spatial relationship being unqualified, by the host device or the another peripheral device, transmitting another spatial relationship between the player device and the peripheral device attached to the player device to the peripheral device,
wherein the another spatial relationship is generated according to the first pose of the peripheral device and a third pose of the player device, and the third pose is generated by the host device or the another peripheral device according to image information related to the player device and is defined in the spatial coordinate system.

8. The tracking method of claim 7, wherein by the host device or the another peripheral device, determining if the spatial relationship between the player device and the peripheral device attached to the player device is qualified or not comprises:
by the host device or the another peripheral device, capturing an image frame related to the player device;
by the host device or the another peripheral device, generating a projection related to the player device on the image frame according to the spatial relationship and the first pose, to obtain a difference related to the player device; and
by the host device or the another peripheral device, comparing the difference with a difference threshold, wherein the spatial relationship is qualified when the difference is smaller than the difference threshold, and the spatial relationship is unqualified when the difference is greater than the difference threshold.

9. The tracking method of claim 7, further comprising:
by the peripheral device, detecting if the another spatial relationship between the player device and the peripheral device attached to the player device is qualified or not; and
in response to a detection of the another spatial relationship being qualified, by the peripheral device, replacing the spatial relationship with the another spatial relationship.

10. A multi-device system, configured to track a player device in a physical environment, and comprising:
a peripheral device, configured to obtain a spatial relationship between the player device and the peripheral device attached to the player device, and configured to, in response to a detection of the spatial relationship being unqualified, update the spatial relationship between the player device and the peripheral device attached to the player device; and
a host device, configured to receive the spatial relationship and a first pose of the peripheral device from the peripheral device, and configured to generate a second pose of the player device according to the spatial relationship and the first pose,
wherein the first pose is generated by the peripheral device attached to the player device, and the spatial relationship, the first pose and the second pose are defined in a spatial coordinate system.

11. The multi-device system of claim 10, wherein the peripheral device is configured to capture an image data of the player device, and is configured to generate a feature point model of the player device according to the image data and a preset three-dimensional (3D) model of the player device,
wherein when the peripheral device is attached to the player device, the peripheral device is configured to generate a third pose of the player device according to the feature point model, and is configured to use the third pose and the first pose to generate an extrinsic data of the player device relative to the peripheral device as the spatial relationship,
wherein the third pose is defined in the spatial coordinate system.

12. The multi-device system of claim 10, wherein the player device is provided with at least one trackable object,
wherein when the peripheral device is attached to the player device, the peripheral device is configured to generate a third pose of the at least one trackable object according to an image data of the at least one trackable object, and is configured to use the third pose and the first pose to generate an extrinsic data of the player device relative to the peripheral device as the spatial relationship,
wherein the third pose is defined in the spatial coordinate system.

13. The multi-device system of claim 10, wherein the peripheral device is further configured to detect if the spatial relationship between the player device and the peripheral device attached to the player device is qualified or not,
wherein the spatial relationship is not updated when the spatial relationship is qualified.

14. The multi-device system of claim 13, wherein the peripheral device is configured to, when the peripheral device is attached to the player device, capture an image frame comprising an image of the player device, is configured to generate a projection of the player device on the image frame according to the spatial relationship, to obtain a difference between the projection and the image, and is configured to compare the difference with a difference threshold,
wherein the spatial relationship is qualified when the difference is smaller than the difference threshold, and the spatial relationship is unqualified when the difference is greater than the difference threshold.

15. The multi-device system of claim 13, wherein the player device is provided with at least one trackable object,
wherein the peripheral device is configured to, when the peripheral device is attached to the player device, capture an image frame comprising an image of the at least one trackable object, is configured to generate a projection of the at least one trackable object on the image frame according to the spatial relationship, to obtain a difference between the projection and the image, and is configured to compare the difference with a difference threshold,
wherein the spatial relationship is qualified when the difference is smaller than the difference threshold, and the spatial relationship is unqualified when the difference is greater than the difference threshold.

16. The multi-device system of claim 10, further comprising another peripheral device, wherein the host device or the another peripheral device is configured to determine if the spatial relationship between the player device and the peripheral device attached to the player device is qualified or not, and is configured to, in response to a determination of the spatial relationship being unqualified, transmit another spatial relationship between the player device and the peripheral device attached to the player device to the peripheral device,
wherein the another spatial relationship is generated according to the first pose of the peripheral device and a third pose of the player device, and the third pose is generated by the host device or the another peripheral device according to image information related to the player device and is defined in the spatial coordinate system.

17. The multi-device system of claim 16, wherein the host device or the another peripheral device is configured to capture an image frame related to the player device, is configured to generate a projection related to the player device on the image frame according to the spatial relationship and the first pose, to obtain a difference related to the player device, and is configured to compare the difference with a difference threshold,
wherein the spatial relationship is qualified when the difference is smaller than the difference threshold, and the spatial relationship is unqualified when the difference is greater than the difference threshold.

18. The multi-device system of claim 16, wherein the peripheral device is further configured to detect if the another spatial relationship between the player device and the peripheral device attached to the player device is qualified or not, and is configured to, in response to a detection of the another spatial relationship being qualified, replace the spatial relationship with the another spatial relationship.

19. The multi-device system of claim 10, further comprising a connection device, wherein the peripheral device is attached to the player device through the connection device,
wherein the peripheral device comprises a camera, and when the peripheral device is attached to the player device, a part of the player device or at least one trackable device arranged on the player device is in a field of view of the camera.

20. A non-transitory computer readable storage medium with a computer program to execute a tracking method applicable to a multi-device system, wherein the multi-device system is configured to track a player device in a physical environment and comprises a host device and a peripheral device, and the tracking method comprises:
by the peripheral device, obtaining a spatial relationship between the player device and the peripheral device attached to the player device;
by the peripheral device, transmitting the spatial relationship and a first pose of the peripheral device to the host device, wherein the first pose is generated by the peripheral device attached to the player device;
by the host device, generating a second pose of the player device according to the spatial relationship and the first pose, wherein the spatial relationship, the first pose and the second pose are defined in a spatial coordinate system; and
in response to a detection of the spatial relationship being unqualified, by the peripheral device, updating the spatial relationship between the player device and the peripheral device attached to the player device.
